(19) United States
(12) Patent Application Publication
(10) Pub. No.: US 2026/0084694 A1
(43) Pub. Date: Mar. 26, 2026

(54) SYSTEM AND METHOD FOR DELAYED DECISION MAKING IN AUTONOMOUS VEHICLES

(71) Applicant: Honda Motor Co., Ltd., Tokyo (JP)

(72) Inventors: David Francis ISELE, Sunnyvale, CA (US); Faizan M. TARIQ, San Jose, CA (US); Avinash SINGH, Santa Clara, CA (US); Sangjae BAE, Mountain View, CA (US); Alexandre MIRANDA ANON, Barcelona (ES); Zheng-Hang YEH, San Jose, CA (US)

(21) Appl. No.: 19/214,621

(22) Filed: May 21, 2025

Related U.S. Application Data
(60) Provisional application No. 63/697,139, filed on Sep. 20, 2024.

(51) Int. Cl. B60W 30/09; B60W 30/095

(52) U.S. Cl. CPC B60W 30/09; B60W 30/0956; B60W 2520/10; B60W 2520/105; B60W 2540/00; B60W 2554/402; B60W 2554/4029; B60W 2554/4045; B60W 2720/10; B60W 2720/24

(57) ABSTRACT

A method and system for automatically selecting a vehicle trajectory for an autonomous vehicle that is maximally compatible with all possible outcomes associated with the various multiple predictions for agents in the environment. The system includes an architecture with a model predictive unit, a speed planner, and a path planner.

### CROSS-REFERENCE TO RELATED APPLICATIONS

This application claims the benefit of Provisional Patent Application No. 63,697,139 filed Sep. 20, 2024, and titled “Delayed-Decision Motion Planning in the Presence of Multiple Predictions,” which is incorporated by reference herein in its entirety.

### BACKGROUND

Autonomous driving technologies rely on solutions for quickly receiving environmental information and providing responses (e.g., accelerate, brake, turn) that facilitate efficient and safe driving. These technologies may utilize various prediction systems to determine likely courses of action for agents in the vehicle's environment.

However, existing systems and methods may not be adapted to determine a course of action for an autonomous agent, including selecting a decision and planning a trajectory for a vehicle considering multiple prediction outputs, in a manner that is both efficient and safe.

There is a need in the art for a system and method that addresses the shortcomings discussed above.

### SUMMARY

Embodiments provide herein disclose methods and systems for operating autonomous vehicles in situations with probabilistic actions for agents in the environment.

In some aspects, the techniques described herein relate to an autonomous driving agent for a vehicle, including: circuitry coupled to one or more sensors of the vehicle, wherein the circuitry is configured to: receive information about a target agent in an environment of the vehicle from the one or more sensors; predict a set of possible future actions for the target agent within the environment of the vehicle; receive a set of probabilities corresponding to the set of possible future actions; convert the set of possible future actions for the target agent to a set of constraints; determine a desired vehicle trajectory for the vehicle based on compatibility between the desired vehicle trajectory and the set of constraints; and control one or more vehicle systems of the vehicle to achieve the desired vehicle trajectory.

In some aspects, the techniques described herein relate to a system, including: a processor configured to: receive information about a target agent in an environment of an autonomous vehicle from one or more sensors; receive a set of possible future actions for the target agent within the environment of the autonomous vehicle; receive a set of probabilities corresponding to the set of possible future actions; convert the set of possible future actions for the target agent to a set of constraints; determine a desired vehicle trajectory for the vehicle based on compatibility between the desired vehicle trajectory and the set of constraints; and generate information for controlling the autonomous vehicle to achieve the desired vehicle trajectory.

In some aspects, the techniques described herein relate to a computer-implemented method for an autonomous vehicle, including: receiving information about a target agent in an environment of the autonomous vehicle from one or more sensors; receiving a set of possible future actions for the target agent within the environment of the autonomous vehicle; receiving a set of probabilities corresponding to the set of possible future actions; converting the set of possible future actions for the target agent to a set of constraints; determining a desired vehicle trajectory for the autonomous vehicle based on compatibility between the desired vehicle trajectory and the set of constraints; and generating information for controlling the autonomous vehicle to achieve the desired vehicle trajectory.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a scenario where an autonomous vehicle must choose a trajectory in the presence of multiple possible actions from an agent in the environment, according to an environment.

FIG. 2 is a schematic view of an architecture for an autonomous vehicle, according to an embodiment.

FIG. 3 is a schematic view of some steps in a process for determining a desired vehicle trajectory and controlling a vehicle according to the desired vehicle trajectory, in the presence of multiple predictions for agent behavior, according to an environment.

FIG. 4 is a schematic view of the vehicle in the scenario of FIG. 1, alongside a model of the scenario constructed by the autonomous driving agent after gathering data about the environment from one or more vehicle sensors, according to an embodiment.

FIG. 5 shows a chart with some possible trajectories for an autonomous vehicle along with a visualization within a model of some of those trajectories, according to an embodiment.

FIG. 6 is a schematic overview of an architecture that may be used by a motion planning system of the autonomous driving agent for finding desired trajectories, according to an embodiment.

FIG. 7 is a schematic view of some equations for use in finding a desired trajectory, according to an embodiment.

FIG. 8 is a schematic view of some equations associated with a model predictive control approach to finding a trajectory, according to an embodiment.

FIG. 9 is a schematic view showing the application of the exemplary system for delayed motion planning to a scenario with multiple external agents, according to an embodiment.

### DETAILED DESCRIPTION

The embodiments may utilize any of the methods and systems as disclosed in the article “Delayed-Decision Motion Planning in the Presence of Multiple Predictions,” to Isele et al., which is included in the Appendix (“Appendix A”) to the present application and herein incorporated by reference in its entirety and referred to as the “Delayed-Decision Article”.

The embodiments may also utilize and of the methods and systems for planning trajectories as disclosed in any of the following applications: U.S. Patent Publication Number 2025/0108836, to Miranda Anon et al., filed Nov. 14, 2023, and titled “Multi-Profile Quadratic Programming (MPQP) for Optimal Gap Selection and Speed Planning of Autonomous Driving”; U.S. Patent Publication Number 2025/0108801, to Miranda Anon et al., filed Nov. 14, 2023, and titled “Multi-Profile Quadratic Programming (MPQP) for Optimal Gap Selection and Speed Planning of Autonomous Driving”; U.S. Patent Publication Number 2025/0108828, to Miranda Anon et al., filed Nov. 2, 2023 and titled “Multi-Profile Quadratic Programming (MPQP) for Optimal Gap Selection and Speed Planning of Autonomous Driving”; and U.S. Patent Publication Number 2025/0108827, to Miranda Anon et al., filed Oct. 27, 2023 and titled “Multi-Profile Quadratic Programming (MPQP) for Optimal Gap Selection and Speed Planning of Autonomous Driving,” each of which applications are hereby incorporated by reference in their entirety and referred to as “the Trajectory Planning Applications.”

The embodiments include methods to operate autonomous vehicles. As used herein, the term “vehicle” refers to any cars, trucks, vans, minivans, SUVs, motorcycles, scooters, boats, watercraft, and aircraft. Vehicles may further comprise any kind of gasoline powered vehicles, hybrid vehicles, electric vehicles, or other vehicles utilizing other suitable kinds of energy sources. Moreover, autonomous vehicles may include any of these types of vehicles, and autonomous driver assistance systems may be used with any of these types of vehicles.

Autonomous driving requires an autonomous driving agent (or simply “AV agent”) in control of the vehicle to quickly assess information within the vehicle's environment and make decisions about vehicle operation in response (for example, to accelerate, brake, or turn). The information may include information about other agents (such as pedestrians and other vehicles) in the environment whose future behaviors may not be known. As predictions systems are able to provide multiple-predictions for one or more agents possible future actions, an AV agent may face technical challenges in planning a trajectory that is simultaneously safe, comfortable, and intuitive to occupants of the vehicle or to other agents in the vehicles environment.

The embodiments provide systems and methods that solve these technical challenges by utilizing a novel architecture that automatically selects a vehicle trajectory that is sufficiently compatible with all possible outcomes associated with the various multiple predictions for agents in the environment. This compatibility with many future scenarios, corresponding to many possible future trajectories for the AV agent's own vehicle, allows the AV agent to delay decision making until a later time so that more information can be gathered about the environment and the vehicle's trajectory adjusted accordingly.

In some embodiments, the architecture includes path and speed planners, as well as a model predictive control (MPC) unit that efficiently finds one a trajectory from the set of all trajectories compatible with all (possible) outcomes, such that the driving performance of the autonomous vehicle is maximized (according to suitable criteria) while preserving flexibility to respond to whichever outcome is ultimately realized.

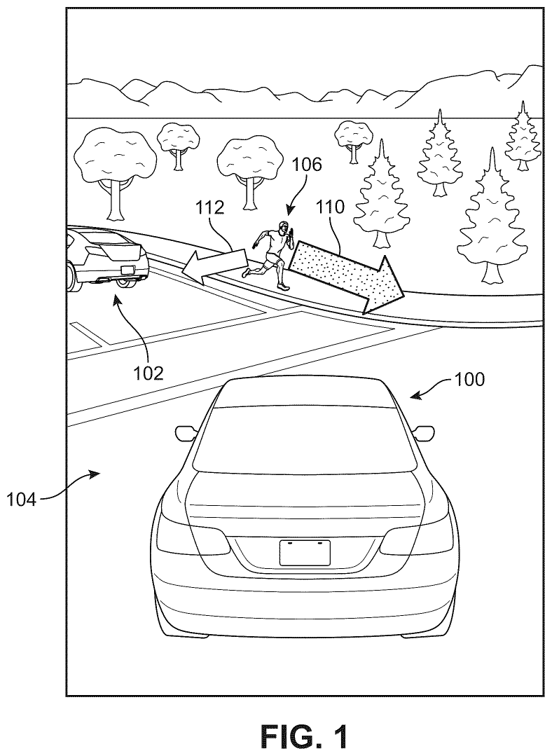

FIG. 1 presents a scenario for better understanding the context for an AV agent making decisions in the presence of probabilistic predictions about other agents'actions. In some cases, the agents in the environment may be referred to as “target agents” to distinguish them from the agent associated with the autonomous vehicle itself. The target agents may include pedestrians as well as other vehicles.

Referring to FIG. 1, an autonomous vehicle (AV) 100 (or simply “vehicle 100”) is traveling along a roadway 102. As vehicle 100 pulls into intersection 104, sensors onboard of vehicle 100 may detect the presence of a pedestrian 106 walking along a sidewalk on the edge of roadway 102.

Prediction systems onboard vehicle 100 may generate a set of probable actions for pedestrian 106. In this simplified example, the systems predicts that pedestrian 106 may intend to continue forward along a first trajectory 110 or turn and cross roadway 102 along a second trajectory 112. Based on evaluating cues in the environment, including, for example, the pedestrian's pose, position, and/or velocity, the systems may determine that pedestrian 106 has an 80% chance of continuing straight and a 20% chance of crossing roadway 102.

In this scenario, an autonomous agent controlling vehicle 100 has to decide how to behave based on this set of possible actions by the pedestrian. Specifically, if the pedestrian does cross roadway 102 in front of vehicle 100, vehicle 100 must brake to ensure vehicle 100 does not collide with pedestrian 106. On the other hand, if the pedestrian does not cross roadway 102, but continues forward, there is no need for vehicle 100 to brake.

In some cases, a vehicle may select a policy that takes actions based on the most probable result. In the scenario of FIG. 1, acting on the most likely assumption that pedestrian 106 will not cross the street leads to an overly aggressive and risky action, in which the vehicle does not preemptively slow down but may have to perform sudden braking at the last minute if the pedestrian begins to cross the road in front of the vehicle. In such a scenario, occupants of the vehicle may feel discomfort at the sudden braking.

In other cases, a vehicle may select a policy that takes actions based on the most cautious result. In the scenario of FIG. 1, acting on the assumption that the vehicle should preemptively brake on the relatively small chance that the pedestrian crosses the road may lead to unnecessary braking if the pedestrian continues straight. This unnecessary braking may lead to confusion for the occupants and/or for other vehicles in the environment.

The exemplary embodiments provide a system and method that utilize a solution that balances different policy goals. For example, in the scenario of FIG. 1, the autonomous vehicle may select a behavior that balances the two extremal policy approaches. In particular, the vehicle may act to slow down so that it is possible to fully brake for the pedestrian if necessary, but not as much as the vehicle would brake under the more cautious policy. The embodiments provide autonomous vehicles that achieve this more balanced policy approach by employing a strategy that delays decision making while selecting actions that maximize the set of possible (and desired) future actions based on current information along with known constraints.

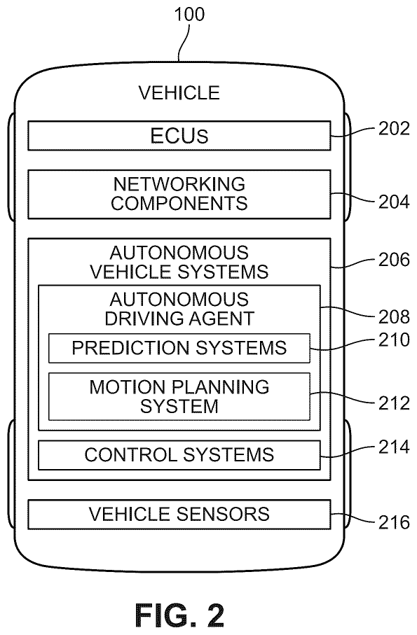

FIG. 2 is a schematic view of an architecture for an autonomous vehicle, according to an embodiment. Referring to FIG. 2, the architecture includes vehicle 100. Vehicle 100 further includes one or more electronic control units 202 (ECUs 202) and networking components 204. ECUs 202 may comprise one or more discrete computing systems that may each include one or more processors, as well as non-transitory computer-readable media (memory) for storing instructions that may be executed by the one or more processors.

Networking components 204 may comprise one or more suitable devices, chips, cards, or other systems for communicating over wired and/or wireless networks. Suitable networking components may include a Wi-Fi card, a cellular network card, a Personal Area Network (PAN) card, a Near Field Communication (NFC) chip as well as other suitable components to facilitate wireless communication between systems of a vehicle and other systems.

Vehicle 100 may also include one or more sensors for sensing vehicle data, occupant data, or other suitable kinds of data. For example, vehicle 100 may include vehicle sensors 216. Vehicle sensors 216 may include cameras, LIDAR sensors, Radar sensors, lasers, steering angle sensors, braking sensors, velocity sensors, wheel speed sensors, acceleration sensors, accelerometers, gyroscopes, GPS sensors, microphones, as well as other suitable sensors for detecting various kinds of vehicle data, including telemetry data. In some cases, vehicle sensor data may be available to one or more systems of vehicle sensors 216 via a controller area network (CAN bus) which further communicates with an onboard diagnostics (OBD) system of the vehicle.

Vehicle 100 may be associated with one or more autonomous vehicle systems. Autonomous vehicle systems 206 may comprise both systems for directly controlling a vehicle as well as autonomous driver assistance systems. For example, autonomous vehicle systems 206 may include control systems 214 that facilitate autonomous driving. Exemplary control systems may include drive-by-wire systems, specifically throttle by wire, brake by wire, shift by wire, steer by wire, and other electrical control systems to facilitate autonomous driving.

Autonomous vehicle systems 206 may also include an autonomous driving agent 208. Autonomous driving agent 208 may comprise processors, circuitry, memory, and software for implementing autonomous driving. In particular, autonomous driving agent 208 may make take in information from one or more sensors, make autonomous decisions, and implement automated driving controls via drive-by-wire or other control systems 214.

In some embodiments, autonomous driving agent 208 (“agent 208”) may comprise one or more prediction systems 210 and a motion planning system 212, as well as other suitable modules or logical components. Prediction systems 210 may comprise any systems, including modules, algorithms, or other processes for providing predictions about the actions of one or more agents in the vehicle's environment. Prediction systems 210 may, for example, receiving sensory data from vehicle cameras or other sensors in order to detect and predict future actions for other vehicles, pedestrians, or other agents in the environment. For example, in the scenario of FIG. 1, a suitable prediction system may capture information about pedestrian 106 and provide a set of possible outcomes (e.g., turn and cross, or continue straight ahead). In some cases, prediction systems 210 may output possible actions and corresponding probabilities for each possible action. For example, in the scenario of FIG. 1, a prediction system may predict that pedestrian will continue straight with a probability of 80% or turn and cross the road with a probability of 20%. Of course, in other cases, prediction systems 210 may output any suitable number of possible outcomes with corresponding probabilities that may be constrained such that the sum over all probabilities is 100%. In some cases, prediction systems 210 output actions for other agents in the form of predicted trajectories for the agents over time.

Motion planning system 212 may utilize information from prediction systems 210 along with other information gathered from the environment to plan an action, including a trajectory, for vehicle 100. To this end, motion planning system 212 may comprise various algorithms and processes for determining a desired trajectory, as discussed in further detail below.

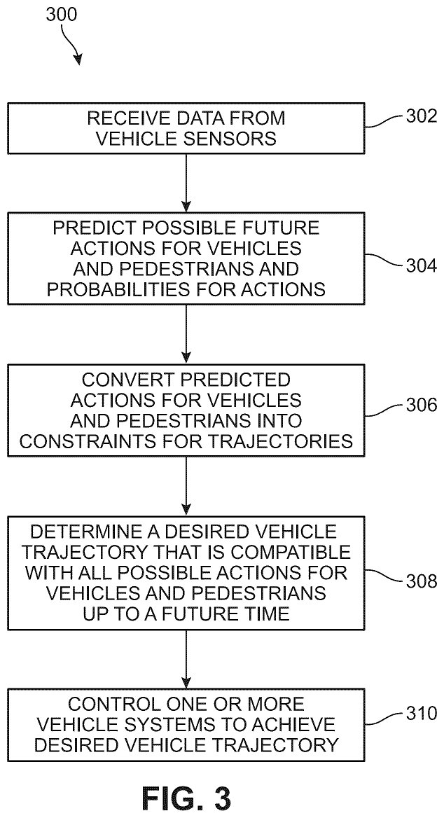

FIG. 3 is a schematic view of some steps in a process 300 for determining a desired vehicle trajectory and controlling a vehicle according to the desired vehicle trajectory, in the presence of multiple predictions for agent behavior. In some cases, one or more of the following steps may be performed by systems of an autonomous vehicle (such as vehicle 100). In some cases, one or more steps may be performed by an autonomous driving agent (such as autonomous driving agent 208).

Starting in step 302, an autonomous driving agent may receive data from one or more vehicle sensors. For example, the agent may receive data from onboard cameras, LIDAR, or other sensors detecting the presence and behaviors (including movements) of various agents in the vehicle's environment.

In step 304, the autonomous driving agent may predict possible future actions for one or more vehicles, pedestrians, or other agents in the vehicle's environment. In some cases, each possible future action may be associated with a corresponding probability. In some cases, step 304 may be performed by one or more prediction systems embedded within the autonomous driving agent (such as prediction systems 210). However, in other cases, the autonomous driving agent may receive predictions from systems external to the agent and/or vehicle.

In step 306, the autonomous driving agent may convert the predicted actions for one or more agents in the vehicle's environment into constraints for the autonomous vehicle's possible trajectories. In some cases, the autonomous driving agent receives possible trajectories for one or more agents along with probabilities for those trajectories. In some cases, the autonomous driving agent uses a spacetime (ST) cell planner to determine constraints based on predicted actions (trajectories). For example, an autonomous agent may use any suitable systems or methods as disclosed in the Trajectory Planning Applications.

In step 308, the autonomous driving agent may determine a desired vehicle trajectory that is compatible with all possible actions for the agents in the environment up to some future time. In particular, the autonomous driving agent may determine a desired vehicle trajectory that is compatible with the constraints determined in step 306. In some cases, it may not be feasible to find a trajectory that is compatible with all possible actions (constraints) up to a given time, and instead a trajectory may be found that is compatible with a sufficiently large number of possible actions.

In step 310, the autonomous driving agent may control one or more vehicle systems to achieve the desired vehicle trajectory. For example, the autonomous driving agent may automatically control acceleration, braking, steering or other vehicle control systems to realize the desired vehicle trajectory for the vehicle over a given time horizon.

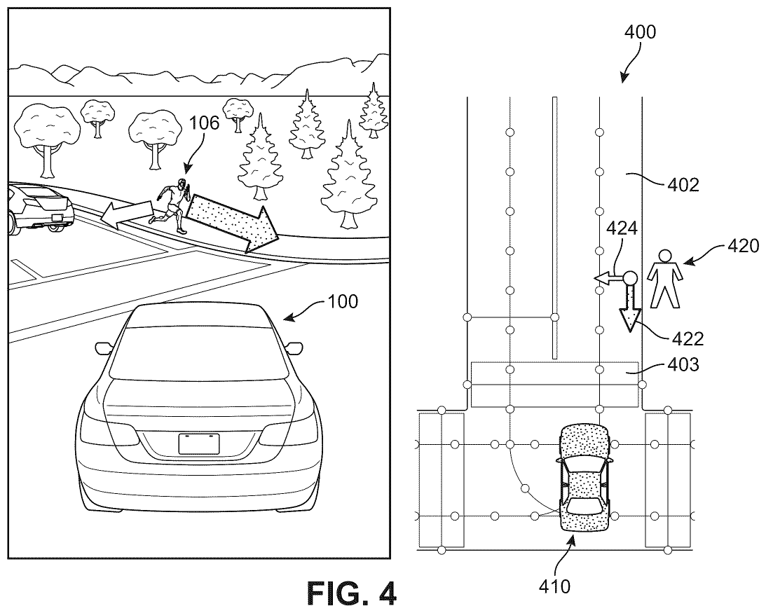

FIG. 4 is a schematic view of vehicle 100 in the scenario of FIG. 1, alongside a model 400 of the scenario constructed by the autonomous driving agent 208 after gathering data about the environment from one or more vehicle sensors. For purposes of illustration, information associated with model 400 is shown graphically, however it may be appreciated that the autonomous driving agent 208 may not utilize such a visual model and may organize and access information in any suitable manner.

As seen in FIG. 4, model 400 includes a space comprised of roadways 402 that are populated by multiple agents. Information about the roadways 402 may be gathered, including information about the lanes, crosswalks, and intersections.

In this relatively simple scenario, model 400 includes an AV agent 410, representative of vehicle 100 controlled by autonomous driving agent 208 (see FIG. 2), and a pedestrian agent 420, representative of pedestrian 106.

Model 400 also includes information about possible actions that agent 420 may take. These include a first action 422, corresponding to walking straight along the side of the road, and a second action 424, corresponding to crossing roadway segment 403 of roadways 402. Each of these actions may be associated with a corresponding probability. For purposes of illustration, the size of the arrows for the first and second actions represent their relative probabilities. In this case, first action 422 has a higher probability of occurring (for example an 80% chance) while second action 424 is less likely (for example, a 20% chance).

In view of the multiple predictions for the actions of agent 420, the autonomous driving agent 208 must find a desired trajectory that does not lead to overly aggressive or cautious behavior and mimics a more human-like response.

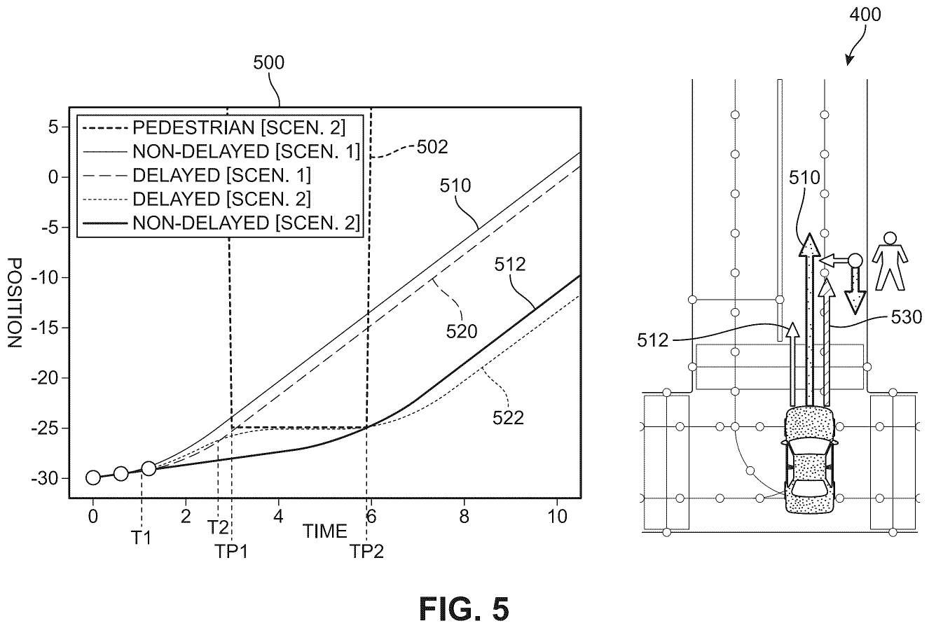

FIG. 5 shows a chart 500 with some possible trajectories for an autonomous vehicle along with a visualization within model 400 of some of those trajectories. In chart 500, the trajectories are shown as a position along the road (y-axis) as a function of time (x-axis).

Different possible actions/behaviors of agents in the environment, including pedestrian 106, may be represented by constraints (or boundaries) within chart 500. Specifically, a box 502 represents the action in which the pedestrian crosses the street in front of the vehicle between time T_{P1} and time T_{P2}. Thus, box 502 represents a boundary condition on possible trajectories that occur in the situation where the pedestrian crosses the street, as the vehicle must be prevented from colliding with the pedestrian. By contrast, if the pedestrian does not cross the street, no such boundary conditions are necessary on the possible trajectories of the vehicle, and thus no other constraints (boxes) are shown for this example.

As seen in FIG. 5, multiple trajectories considered by the system overlap initially (that is, near time=0), as all possible future trajectories must be consistent with the current trajectory of the vehicle at time zero. Over time, the different trajectories begin to diverge in a way that satisfies different constraints that are determined, initially, by probabilities, and eventually, by new information.

Chart 500 shows two trajectories that are found without using the delayed decision methods of the embodiments. These include a first non-delayed trajectory 510 (also indicated schematically in model 400 within FIG. 5) corresponding to an overly aggressive response to the possible actions of the pedestrian in which agent 410 assumes the pedestrian will not cross the street (scenario 1), and a second non-delayed trajectory 512 (also indicated schematically in model 400) corresponding to an overly cautious response, in which agent 410 assumes the pedestrian will cross (scenario 2). Because both trajectories are determined early on (without delay), the final trajectory may end up deviating significantly from these trajectories as new information arrives. For example, if the agent selects first non-delayed trajectory 510, assuming the pedestrian will not cross, but finds at a later time that the pedestrian is crossing, the vehicle may have to brake suddenly to avoid a collision. This may cause confusion and/or discomfort for the vehicle's occupants as well a concern for pedestrians, and/or surrounding vehicles. Likewise, if the agent selects the second non-delayed trajectory 512, assuming the pedestrian will cross, but finds at a later time the pedestrian is continuing straight, the vehicle may find itself unnecessarily braking in an empty intersection. This may also cause confusion for the occupants, pedestrians, and/or surrounding vehicles and in some cases discomfort for the occupants as well.

Using the exemplary systems and methods, agent 410 is able to identify additional trajectories that may be more optimal compared to first non-delayed trajectory 510 and second non-delayed trajectory 512 (which are also shown schematically as a single composite delayed trajectory 530 within model 400). These include a first delayed trajectory 520 and a second delayed trajectory 522. Both of these trajectories involve initially traveling at a speed that is intermediate to the speeds of first trajectory 510 and second trajectory 512 for a period of time. And both trajectories allow agent 410 to delay making a decision about braking significantly for a pedestrian until additional information has arrived. But whereas first non-delayed trajectory 510 and second non-delayed trajectory 512 begin to diverge at a time T1, first delayed trajectory 520 and second delayed trajectory 522 only begin to diverge significantly at a later time T2. This allows for more information to be gathered before agent 410 has to choose between following one of the two possible trajectories corresponding to the different actions of the pedestrian.

It may be seen that utilizing the exemplary systems and methods allows the autonomous driving agent to generate possible trajectories that preserve more optionality in the future while maximizing performance (including safety and comfort). In the example of FIG. 5, in particular, the exemplary agent selects two trajectories around time T1 that are compatible with either pedestrian scenario, at least until a future time T2. The actions of the agent therefore conform to behaviors that a human driver would be expected to make, rather than behaviors that are maximal with respect to a given extremal policy (such as overly aggressive or overly cautious behaviors).

The autonomous driving agent of the embodiments may include provisions for selecting trajectories that are compatible with many possible agent outcomes and therefore facilitate delayed decision making. Delaying decisions allows the autonomous driving agent to wait until additional information has arrived, at which point a “correct” or “optimal” decision can be determined and made. Instead of making immediate decisions regarding multiple predictions, the agent may position itself to be ready to adjust. For example, as in the scenario of FIGS. 4 and 5, agent 410 makes immediate decisions that are compatible with both first delayed trajectory 520 and second delayed trajectory 522, even though those trajectories will diverge at some future time.

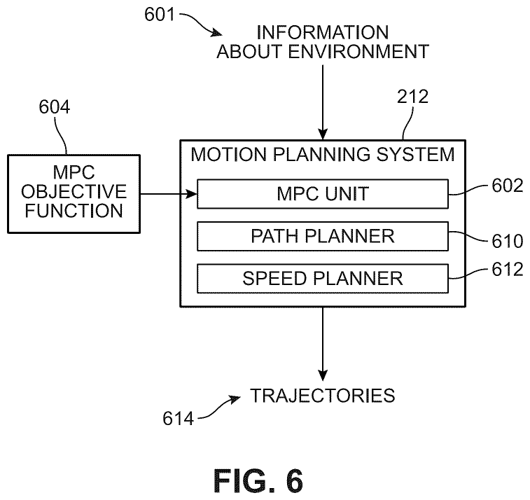

FIG. 6 is a schematic overview of an architecture that may be used by motion planning system 212 of the autonomous driving agent 208 for finding desired trajectories using the exemplary delayed decision in motion planning approach.

The autonomous driving agent may gather information 601 about agents in the environment and provide them to the motion planning system. This may include gathering information about the agents'current positions and velocities, along with predictive information about the agents'possible future actions (including possible future trajectories for the agents).

The architecture includes a model predictive control (MPC) unit 602 that solves one or more optimization problems. In some cases, MPC unit includes one or more algorithms for maximizing the expectation value of a given function using principles of model predictive control. In the exemplary embodiment, the MPC unit is formulated to find a trajectory by optimizing an MPC objective function 604, which is discussed in further detail below.

In some embodiments, the path planning and speed planning are decoupled and handled by different planners, including a path planner 610 and speed planner 612. The embodiments may utilize any of the systems, methods, algorithms, processes, or other features for speed planning and/or path planning as disclosed in the Trajectory Planning Applications.

The output of motion planning system 212 includes trajectories 614. The autonomous driving agent may use trajectories 614 to control one or more vehicle control systems.

Autonomous agents of the exemplary embodiments may determine desired trajectories that are compatible, in some sense, with the set of possible future actions for one or more agents (such as pedestrians and/or vehicles). This sense of compatibility may be formalized by considering the set of all possible future trajectories for the AV agent that are consistent with all possible future actions of the external agents. The desired trajectory may then be the trajectory that is compatible with all such possible future trajectories (or a large subset of all possible future trajectories) while also maximizing driving performance (such as comfort and efficiency).

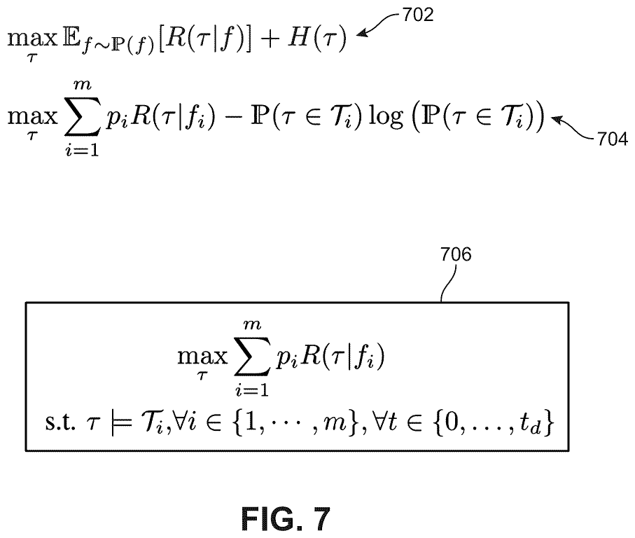

More formally, the desired trajectory may be maximally compatible with all such possible future trajectories (τ) in the sense that it maximizes the expectation value of an agent's reward function (R(τ|f)) weighted by the probabilities of different actions by external agents and further regularized with a maximum entropy term (H(τ)), as in equation 702 of FIG. 7. The maximum entropy term is included to maximize the number of constraints that can be satisfied simultaneously for as long as possible, thereby allowing the agent more time for information to arrive about external agents'actions. For example, in the scenario of FIGS. 4 and 5, this corresponds to finding trajectories that, at least up to some future time, are consistent with (1) no constraint on the trajectory because the pedestrian doesn't cross the street and (2) a constraint (box 502) due to the presence of the pedestrian crossing the street.

Equation 702 may be reformulated in terms of transition probabilities (P) as in equation 704. However, because maximizing the entropy term of the formulation does not necessarily result in a maximum reward, the principle of maximizing the entropy may be satisfied by further reformulating the problem as an expectation value of the reward function such that a constraint corresponding to maximal entropy is satisfied, as in equation 706. Equation 706 therefore provides an optimization problem for solving for the trajectory τ that maximizes the expectation of the reward function calculated for every possible scenario f, weighted by the probability that f will occur. Moreover, the maximum energy condition is enforced by a constraint that that trajectory be part of the set of all possible trajectories τ (subject to the boundary conditions) up to some time t_{d}.

While equation 706 represents a general formulation that formalizes the idea of selecting trajectories that are maximally compatible with future possible trajectories to allow for delayed decision making, finding exact solutions to such a formulation may be technically infeasible for many real-world scenarios. Instead, an autonomous driving agent may incorporate algorithms that determine trajectories that solve related problems in specific implementations including Model Predictive Control (MPC), Graph Search, and Reinforcement Learning. In the exemplary implementation, as discussed above and shown in FIG. 6, the embodiments employ a motion planning system 212 with an MPC unit 602 as well as utilizing a path planner 610 and speed planner 612.

Motion planning system 212 operates by decoupling path planning and speed planning, with the multiple predictions (e.g., multiple possible trajectories for a pedestrian) being handled by speed planner 612. Constraints associated with a prediction are converted to piecewise linear upper and lower bounds. As an example, the prediction that pedestrian 106 will cross the street in the scenario of FIG. 4 is converted to an upper bound associated with box 502 in FIG. 5. Given the piecewise linear bounds obtained from a cell planner (for example, using speed planner 612), motion planning system 212 simultaneously solves for multiple trajectories corresponding to multiple futures where all trajectories are locked up to time t_{d}. In some cases, the decision time t_{d} may be a tunable parameter. In other cases, the decision time may be found by an explicit binary search.

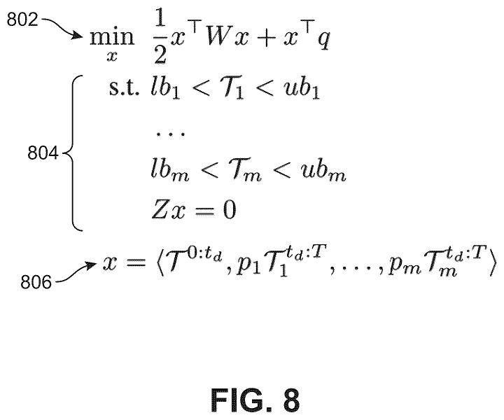

MPC unit 602 includes algorithms that solve the objective function 802, subject to constraints 804 as in FIG. 8. In some cases, objective function 802 is designed to promote comfort and reduce travel time, thus rewarding typical features of a driving experience valued by human occupants. The objective function 802 is minimized to find the optimal trajectory x. Here, W is a diagonal matrix that encodes the weights for smoothness. The parameter q is zero everywhere except the final displacement which is used to encourage large displacement from the starting position thereby reducing travel time.

The piecewise lower and upper bounds associated with constraints 804 enforce safety (e.g., ensure the vehicle does not collide with a pedestrian or other vehicle). The equation involving Z, also part of constraints 804, enforces the initial conditions and vehicle dynamics.

MPC unit 602, in combination with speed planner 612, solves for a trajectory x (equation 806). The trajectory includes a concatenated position, velocity, acceleration and jerk for each time step for each trajectory weighted. The probability associated with each possible trajectory τ is further embedded within x. A common locked portion of each trajectory τ^{0:td} td is also included.

Embodiments may also include provisions for managing large numbers of constraints or otherwise problematic constraints. Various provisions for managing these complexities are disclosed in the Delayed Decision Article included in the Appendix. It may be appreciated that the embodiments may utilize any of these disclosed provisions as part of the motion planning architecture.

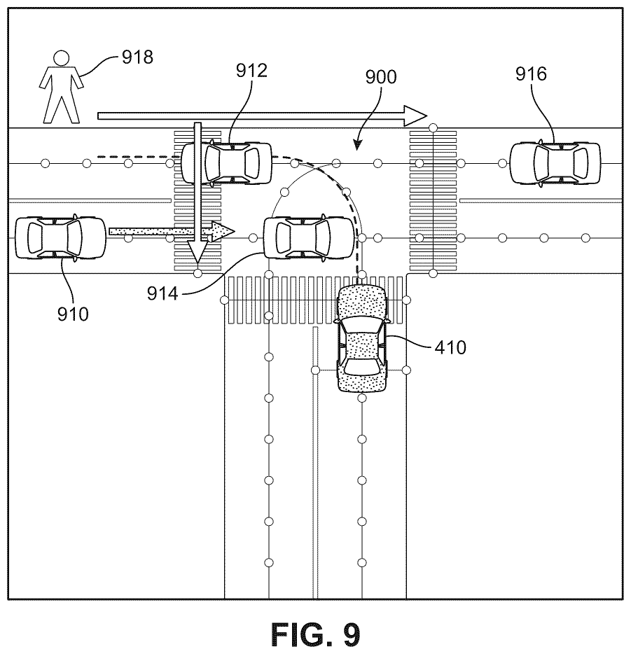

FIG. 9 is a schematic view showing the application of the exemplary system for delayed motion planning to a scenario with multiple external agents, rather than a single pedestrian as in the example of FIG. 1. As shown in FIG. 9, agent 410 may be traveling towards an intersection 900 in which multiple vehicles (including first vehicle 910, second vehicle 912, third vehicle 914, and fourth vehicle 916) are all passing through, and optionally, turning. Likewise, a pedestrian 918 is walking towards the intersection and may possibly turn. The agent 410 may receive information about each of these agents, including possible actions with associated probabilities, from prediction systems 210. The exemplary methods described above allow agent 410 to select trajectories based on delayed decision making such that the operation of the vehicle optimizes for safety, comfort, and human-like decision making in such complex scenarios. In particular, the architecture of FIG. 6 may be applied to multiple agents with multiple possible actions to determine a desired trajectory for the vehicle at all times.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example.

Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. An autonomous driving agent for a vehicle, comprising:
circuitry coupled to one or more sensors of the vehicle, wherein the circuitry is configured to:
receive information about a target agent in an environment of the vehicle from the one or more sensors;
predict a set of possible future actions for the target agent within the environment of the vehicle;
receive a set of probabilities corresponding to the set of possible future actions;
convert the set of possible future actions for the target agent to a set of constraints;
determine a desired vehicle trajectory for the vehicle based on compatibility between the desired vehicle trajectory and the set of constraints; and
control one or more vehicle systems of the vehicle to achieve the desired vehicle trajectory.

2. The autonomous driving agent according to claim 1, wherein the one or more sensors include a camera.

3. The autonomous driving agent according to claim 1, wherein the circuitry is configured to determine the desired trajectory using model predictive control.

4. The autonomous driving agent according to claim 3, wherein using model predictive control includes solving an objective function that promotes comfort and reduces travel time for the vehicle.

5. The autonomous driving agent according to claim 4, wherein the objective function includes a vector comprised of a concatenated position, velocity, acceleration, and jerk for each time step.

6. The autonomous driving agent according to claim 5, wherein the vector incorporates information from the set of probabilities.

7. The autonomous driving agent according to claim 1, wherein the target agent is another vehicle.

8. The autonomous driving agent according to claim 1, wherein the target agent is a pedestrian.

9. A system, comprising:
a processor configured to:
receive information about a target agent in an environment of an autonomous vehicle from one or more sensors;
receive a set of possible future actions for the target agent within the environment of the autonomous vehicle;
receive a set of probabilities corresponding to the set of possible future actions;
convert the set of possible future actions for the target agent to a set of constraints;
determine a desired vehicle trajectory for the vehicle based on compatibility between the desired vehicle trajectory and the set of constraints; and
generate information for controlling the autonomous vehicle to achieve the desired vehicle trajectory.

10. The system according to claim 9, wherein the processor is configured to determine the desired vehicle trajectory using model predictive control.

11. The system according to claim 9, wherein using model predictive control includes solving an objective function that promotes comfort and reduces travel time for the autonomous vehicle.

12. The system according to claim 11, wherein the objective function includes a vector comprised of a concatenated position, velocity, acceleration, and jerk for each time step.

13. The system according to claim 12, wherein the vector incorporates information from the set of probabilities.

14. The system according to claim 9, wherein the processor is configured to convert the set of possible future actions for the target agent to the set of constraints using a spacetime cell planner.

15. A computer-implemented method for an autonomous vehicle, comprising:
receiving information about a target agent in an environment of the autonomous vehicle from one or more sensors;
receiving a set of possible future actions for the target agent within the environment of the autonomous vehicle;
receiving a set of probabilities corresponding to the set of possible future actions;
converting the set of possible future actions for the target agent to a set of constraints;
determining a desired vehicle trajectory for the autonomous vehicle based on compatibility between the desired vehicle trajectory and the set of constraints; and
generating information for controlling the autonomous vehicle to achieve the desired vehicle trajectory.

16. The computer-implemented method according to claim 15, wherein determining the desired vehicle trajectory includes using model predictive control.

17. The computer-implemented method according to claim 16, wherein using model predictive control includes solving an objective function that promotes comfort and reduces travel time for the vehicle.

18. The computer-implemented method according to claim 17, wherein the objective function includes a vector comprised of a concatenated position, velocity, acceleration, and jerk for each time step.

19. The computer-implemented method according to claim 18, wherein the vector incorporates information from the set of probabilities.

20. The computer-implemented method according to claim 15, wherein determining the desired vehicle trajectory includes using a path planner and a speed planner.
